(19) United States
(12) Patent Application Publication
(10) Pub. No.: US 2001/0016035 A1
(43) Pub. Date: Aug. 23, 2001

(54) Method and system for control of calls in a telecommunication network

(76) Inventor: Juha-Pekka Manner, Vantaa (FI)

Correspondence Address: Michael B. Lasky, Altera Law Group, LLC, Suite 100, 6500 City West Parkway, Minneapolis, MN, 55344-7701, US

(21) Appl. No.: 09/750,542

(22) Filed: Dec. 28, 2000

Related U.S. Application Data
(63) Continuation of application No. PCT/FI99/00611, filed on Jul. 12, 1999.

(30) Foreign Application Priority Data
Jul. 13, 1998 (FI) 981601

(51) Int. Cl. H04M 15/00

(52) U.S. Cl. 379/115.01; 379/133; 379/114.01

(57) ABSTRACT

The invention relates to a method and system for limiting the price and/or number of calls in a telecommunication system comprising a telecommunication network maintained by a teleoperator and terminal equipment connected by a subscription to the telecommunication network. In the method of the invention, subscription-specific account information defined in conjunction with the telecommunication network is controlled by means of the terminal equipment,,said information being used to set a maximum limit for the price and number of calls from the subscription. The system of the invention comprises means for controlling, by means of the terminal equipment, subscription-specific account information defined in conjunction with the telecommunication network, in which system the account information is used to set maximum limits for the price and number of calls.

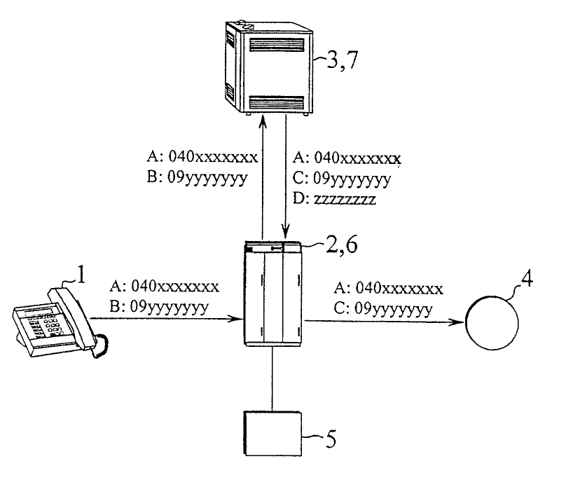

The present invention relates to a method and system for limiting the price and number of calls in a telecommunication system.

People often need to make telephone calls in situations where they cannot use their own home or mobile telephones. The traditional solution to this problem is to use a telephone booth. However, telephone booths are often out of order when they are needed; on the other hand, their number is continuously decreasing as the number of mobile telephones is increasing. Phone cards implemented in a network are one solution for making a call using any telephone without the lender of the telephone being charged for the call. The caller calls a free number, gives his/her username and password and the number of a public network, whereupon the call is connected to this number. However, the fear of a high call charge may be an obstacle to lending one's mobile telephone to someone else. The lender cannot be sure that the borrower is really calling a telephone service behind a free number but e.g. an expensive telephone service. There is also the risk of the borrower stealing the mobile telephone. Another topical question regarding mobile telephone services is the service, primarily intended for parents and concerning calls made by their children, for limiting the monthly payments for calls. The problem with this solution is that the service must be ordered beforehand and cannot be controlled by the user.

The object of the present invention is to solve the problems described above. A specific object of the present invention is to disclose a new type of method and system designed to enable the client of a teleoperator to him/herself limit the number and price of calls made via his/her subscriber line, at any time he/she likes.

The invention concerns a method for limiting the price and/or number of calls in a telecommunication system comprising a telecommunication network maintained by a teleoperator and a telecommunication terminal connected to the telecommunication network via a subscription. ‘Subscription’ refers to an agreement requiring technical and administrative measures between teleoperator and subscriber about connecting the subscriber's terminal equipment to a point comprised in the telecommunication network, i.e. to a port with an interface for the terminal equipment. In the invention, subscription-specific account information defined in the telecommunication network and used to set a maximum limit to the price and number of calls made via the subscription is controlled via the terminal equipment.

In a preferred embodiment of the invention, the account information is activated by making a call from the terminal equipment to an appropriate number, e.g. a free number, the subscription being identified by the calling line identity transmitted in the network signalling. In a preferred case, when activating the account information, a maximum limit for the number of calls, preferably for the price of calls, is defined.

In a preferred embodiment of the invention, the account information is activated and maximum limits for the number and price of calls are defined by making a call to an appropriate telephone number, e.g. a free number. The telephone number is of the form xxxx yy AABB, where AA is a maximum number of calls, BB is a maximum price and xxxx yy is e.g. the beginning of a free number. In this presentation, the length of the string does not define the number of signs in the actual representation; for instance, AA is presented as a symbol, the string AA may have any finite length. Deactivation of the account information is preferably accomplished by making a call from the terminal equipment to an appropriate number, e.g. a free number.

In a preferred embodiment of the invention, in conjunction with control of account information, a subscription-specific identifier, e.g. a secret identification number for verification of the user's identity, is supplied from the terminal equipment. The data are preferably transmitted as DTMF signals (DTMF, Dual-Tone Multifrequency Dialing) from the terminal equipment when the account information is being modified.

The invention also relates to a system for limiting the price and/or number of calls in a telecommunication system comprising a telecommunication network maintained by a teleoperator and terminal equipment connected to the telecommunication network via subscription. The system comprises means for controlling subscription-specific account information defined in conjunction with the telecommunication network by means of the terminal equipment, the account information being used to set maximum limits for the price and number of calls made from the subscription.

In a preferred embodiment of the invention, the system comprises means for activating the account information by calling an appropriate number from the terminal equipment and means for identifying the subscription by the calling line identity transmitted in the signalling in the network. The system preferably comprises means for defining a maximum number of calls in the account information for the subscription, and, in a preferred embodiment, means for defining a maximum price of calls in the account information for the subscription.

In a preferred embodiment of the invention, the system comprises means for activating the account information and means for defining a maximum number of calls by making a call to an appropriate telephone number, which is of the form xxxx yy AABB, where AA is a maximum number of calls, BB is a maximum price and xxxx yy is e.g. the beginning of a free number. The system preferably comprises means for deactivating the account information by making a call from the terminal equipment to an appropriate number, e.g. a free number.

In a preferred embodiment of the invention, the system comprises means for giving a subscription-specific identifier in conjunction with control of account information. The identifier is used to verify the user's identity, i.e. whether the person making modifications in the account information is entitled to do so. The system preferably comprises means for transmitting data in the form of DTMF signals from the terminal equipment when the account information is being modified.

The invention makes it possible to lend a telecommunication terminal, such as a mobile telephone or a wired-network telephone, to anyone against a fixed payment. Thus, each telecommunication terminal can be thought of as a public telephone, so that e.g. service stations or kiosks can use their own private subscriptions as customer telephones as well. The invention also makes it possible to implement e.g. a service for the rental of mobile stations, with call prices and number of calls defined by a rental agreement. As the invention allows a limit to be set for both the price and number of calls, the leasing party will be able to define a gross profit resulting from the calls. A corresponding advantage also applies to the ordinary user; one can lend one's mobile telephone to anyone without a fear of incurring large telephone bills.

In the following, the invention will be described by the aid of a few examples of its embodiments with reference to the attached drawing, which presents a diagram representing an embodiment of the invention.

Using the method and system of the invention, it is possible to implement e.g. a service that allows the owner of a subscription or telecommunication terminal 1 to set a limitation on the use of his/her subscription almost in real time. The service can be activated separately, in other words, one can select whether the calls are to be always transmitted via the service or only upon activation of the service. The service comprises three stages; activation, calling and deactivation. Activation can be done either after deactivation or at any time during a call. The service is activated by calling a free number, and the caller is identified by the calling line identity (CLI) transmitted with the network signalling. In conjunction with activation, the caller specifies an allowed number of calls and a maximum total call price. Activation can be accomplished e.g. by calling a free number like 0800 xx AABB, where AA is the allowed maximum number of calls and BB is the total maximum call price. If necessary, the AA and BB data are transmitted to the service e.g. by using DTMF keys after a speech connection has been established. Activation can also be made subject to user identification by a secret identifying code, thus preventing possible misuse. After activation, all calls made from the subscription will be transmitted via the service. The number and total price of calls made are maintained in a service database. The calculation of call price may be carried out e.g. in the telephone exchange 6, in which case, upon termination of the call, the exchange will send information giving the call price to a service control point 3 (SCP). In one embodiment, the call price is calculated in the service control point 3, in which case the latter also controls the call tariffs. If the values specified in conjunction with activation are exceeded, the service will prevent any further calls from the subscription. The service is deactivated by calling another free number, and the subscriber is identified by the calling line identity in the same way as in the case of activation. For deactivation of the service, the caller is always asked to give a secret identifying code.

The invention can be implemented e.g. by using intelligent network (IN) services or SN/IP base services (SN/IP, Service Node/Intelligent Peripheral) . In the following, referring to the drawing, an embodiment of the invention in an intelligent network environment will be described.

With the service of the invention in the active state, a calling party (040xxxxxxx) dials the number (09yyyyyyy) of a called party on a telecommunication terminal 1. The representation of the telephone numbers is only intended as an example and does not indicate any definite telephone number or the beginning of one. The telecommunication terminal 1 is connected to a service switching point 2. The terminal 1 may be e.g. a mobile telephone, a wired-network telephone or a corresponding piece of data terminal equipment. Based on the subscriber data in the HLR (Home Location Register) or in the wired-network exchange, the service switching point 2 (SSP) identifies the subscriber as an intelligent-network subscriber and connects the call to a service control point 3. The service switching point 2 and the service control point 3 communicate using the Core1NAP protocol as defined fined by the ETSI (European Telecommunication Standards Institute). Using a DP message as defined by the Core1NAP protocol, the service switching point 2 sends the calling line identity (A-number, CLI) and the digits (B-number) dialled by the subscriber to the service control point 3.

The service control point 3 identifies the subscriber by the calling line identity. If the service has been activated, then the service control point 3 will verify that the allowed number of calls or the maximum total call price has not been exceeded. If calling is allowed, the control point 3 will increment the number of calls by one and compute the remaining conversation time. The conversation time is calculated on the basis of the time of day and the B-number selected, among other things. If calling is not allowed, then the call is disconnected after an appropriate message.

The service logic of the service control point 3 returns a routing number (C-number 09yyyyyyy) to the service switching point 2, giving the remaining conversation time at the same time. In addition to the routing number, billing data (D-number zzzzzzzz) to be added to the call record 5 is transmitted to the service switching point 2. The switching point 2 connects the call normally on the basis of the routing number C to the right address 4. If the allowed conversation time ends during the call, then the switching point 2 will play a recorded message and terminate the call. After terminating the call, the switching point 2 produces a corresponding call record in which, in addition to the normal call data, it writes the data sent by the service control point 3, i.e. the D-number (zzzzzzzz).

In a SN/IP environment, a service node 7 (SN, Service Node) is connected to the telephone exchange 6. The caller dials a called party number on a telecommunication terminal 1 connected via a subscription.

Based on the data in the HLR or on the subscriber data in the wired-network exchange, the exchange identifies the caller as a subscriber to a service as provided by the invention and connects the call to the service node 7.

The exchange 6 sends the calling line identity (A-number, CLI) and the digits dialled by the subscriber (B-number) to the service node 7. The signalling between the exchange 6 and the service node 7 may be e.g. ISDN format ISUP signalling (ISDN, Integrated Services Digital Network; ISUP, ISDN User Part), 30B+D or equivalent. The service node 7 identifies the subscriber on the basis of the calling line identity (040xxxxxxx). If the service according to the invention is in an active state, then the service logic of the service node 7 will check that the allowed number of calls or the maximum total call price has not been established. If calling is allowed, then the service node 7 will increment the number of calls by one and compute the remaining conversation time. The conversation time is calculated on the basis of the time of day and the called party number selected (09yyyyyyy), among other things. If calling is not allowed, then the call is disconnected after an appropriate message. After this, the service logic of the service node 7 connects the call normally on the basis of the routing number C (09yyyyyyy) to the right address 4. If the allowed conversation time ends in the middle of the call, then the service node 7 will play a recorded message and terminate the call.

At the end of the call, the exchange produces a corresponding call record. If any additional information is to be added to the call record, then the call record 5 has to be produced in the service node 7.

The account information according to the invention is stored e.g. in conjunction with the call record 5 or some network component, such as e.g. the service switching point 2, the service control point 3 or the service node 7, which preferably are linked to the call record 5.

The method and system of the invention can be applied e.g. to a service in which the account information for a mobile subscriber is stored in the telecommunication network. In the following, the service is called Prepaid service. All calls are transmitted via the Prepaid service, and the account information is updated on the basis of call price. By adding a service according to the invention as a part of the Prepaid service, the holder of the Prepaid service can safely lend his/her own mobile telephone to anyone; such a mobile telephone can be compared to a telephone booth. The lender of the telephone may charge the caller the price of e.g. five minutes for a call with a four-minute maximum conversation time. Thus, the lender will earn a sum corresponding to one minute of conversation time. For the operator, the service will create more traffic, thus improving the network utilisation rate. If necessary, the telephone numbers used for activation/deactivation of the service may be subject to charge so that a desired price can be charged for these calls. The Prepaid service is also available to wired-network subscribers. Natural users of the service of the invention are service stations, kiosks etc.

The invention is not restricted to the examples of its embodiments described above, but many variations are possible within the scope of the inventive idea defined in the claims.

1. Method for limiting the price and/or number of calls in a telecommunication system comprising a telecommunication network maintained by a teleoperator and terminal equipment (1) connected via a subscription to the telecommunication network, characterised in that subscription-specific account information defined in conjunction with the telecommunication network is controlled by means of the terminal equipment (1), said information being used to set a maximum limit for the price and number of calls.

2. Method as defined in claim 1, characterised in that the account information is activated by calling an appropriate number from the terminal equipment (1), the subscription being identified by the calling line identity transmitted in the network signalling.

3. Method as defined in claim 1 or 2, characterised in that, in conjunction with the activation of the account information, a maximum limit is defined for the number of calls from the subscription.

4. Method as defined in any one of the preceding claims 1-3, characterised in that, in conjunction with the activation of the account information, a maximum limit is defined for the total price of calls from the subscription.

5. Method as defined in any one of the preceding claims 1-4, characterised in that the account information is activated and the maximum limits for the number and price of calls from the subscription are defined by calling an appropriate telephone number, said telephone number being of the form xxxx yy AABB, where AA is the maximum number of calls and BB is the maximum price.

6. Method as defined in any one of the preceding claims 1-5, characterised in that the account information is deactivated by calling an appropriate number from the terminal equipment (1).

7. Method as defined in any one of the preceding claims 1-6, characterised in that, in conjunction with the control of the account information, a subscription-specific secret identifier for the verification of the user's identity is given via the terminal equipment (1).

8. Method as defined in any one of the preceding claims 1-7, characterised in that the information is transmitted in the form of DTMF signals from the terminal equipment (1) when the account information is being modified.

9. System for limiting the price and/or number of calls in a telecommunication system comprising a telecommunication network maintained by a teleoperator and terminal equipment (1) connected via a subscription to the telecommunication network, characterised in that the system comprises means for controlling, using the terminal equipment (1), subscription-specific account information defined in conjunction with the telecommunication network, in which system the account information is used to set maximum limits for the price and number of calls.

10. System as defined in claim 9, characterised in that the system comprises means for activating the account information by making a call from the terminal equipment (1) to an appropriate number and means for identifying the subscription on the basis of the calling line identity transmitted in the network signalling.

11. System as defined in claim 9 or 10, characterised in that the system comprises means for defining a maximum number of calls in the account information for the subscription.

12. System as defined in any one of the preceding claims 9-11, characterised in that the system comprises means for defining a maximum call price in the account information for the subscription.

13. System as defined in any one of the preceding claims 9-12, characterised in that the system comprises means for activating the account information and means for defining a maximum number of calls and a maximum call price by making a call to an appropriate telephone number, said telephone number being of the form xxxx yy AABB, where AA is the maximum number of calls and BB is the maximum price.

14. System as defined in any one of the preceding claims 9-13, characterised in that the system comprises means for deactivating the account information by calling an appropriate number from the terminal equipment.

15. System as defined in any one of claims 9-14, characterised in that the system comprises means for giving a secret subscription-specific identifier by means of the terminal equipment (1) to allow verification of the user's identity in conjunction with control of the account information.

16. System as defined in any one of the preceding claims 9-15, characterised in that the system comprises means for transmitting the account information in the form of DTMF signals from the terminal equipment (1) when the account information is being modified.
